(19) United States
(12) Patent Application Publication
(10) Pub. No.: US 2024/0067045 A1
(43) Pub. Date: Feb. 29, 2024

(54) POWER CONTROL SYSTEM, BATTERY SYSTEM, AND CONTROL METHOD OF BETTERY SYSTEM

(71) Applicant: MIH CONSORTIUM, Taipei (TW)

(72) Inventor: KUO-HUA CHEN, Taipei (TW)

(21) Appl. No.: 18/237,082

(22) Filed: Aug. 23, 2023

Related U.S. Application Data
(60) Provisional application No. 63/400,198, filed on Aug. 23, 2022.

(51) Int. Cl. B60L 58/19; B60L 53/20; B60L 53/80

(52) U.S. Cl. CPC B60L 58/19; B60L 53/20; B60L 53/80

(57) ABSTRACT

A battery system for electric vehicles is provided. The battery system includes a first battery module, a second battery module configured to accommodate multiple swappable batteries and a switch device. The switch device is configured to switch a first connection configuration between the first battery module and the second battery module, and to switch a second connection configuration between the swappable batteries when switching the first connection configuration. Each of the first connection configuration and the second connection configuration includes a series connection and a parallel connection. In addition, a power control system and a control method of the battery system are also provided.

### CROSS-REFERENCE TO RELATED APPLICATION

The present application claims the benefit of and priority to U.S. Provisional Patent Application Ser. No. 63/400,198, filed on Aug. 23, 2022 in the US Patent and Trademark Office, entitled “FIXED AND SWAPPABLE BATTERY DESIGN,” the contents of which are hereby fully incorporated herein by reference for all purposes.

### FIELD

The present disclosure generally relates to batteries for electric vehicles and, more particularly, to a power control system, a battery system, and a control method of the battery system for electric vehicles.

### BACKGROUND

An Electric Vehicle (EV) generally refers to a vehicle that at least partially uses electric energy as the power source, and is a new energy vehicle. Due to limitations on the energy density of energy storage units, the maximum driving range of Battery Electric Vehicles (BEV) that rely entirely on battery supply has been a deciding factor for its popularity.

In recent years, with the development of new battery technologies, such as lithium-ion batteries and solid-state batteries, the maximum driving range of the BEVs has become more acceptable. However, due to various factors such as road conditions, traffic situations, temperature, and load, the efficiency and the capacity of batteries may fluctuate, and it may be difficult to accurately estimate the remaining driving range of the BEVs. As such, efficiently charging or swapping the batteries are new challenges of BEVs. As for charging, the charging speed of the BEVs currently differs greatly from the refueling speed of gasoline vehicles. As for battery swapping, the battery pack, which can weigh several hundred kilograms, makes it difficult to swap batteries on demand.

### SUMMARY

In view of the above, the present disclosure provides a power control system, a battery system, and a control method of the battery system for electric vehicles (EVs), which use a second battery module leveraging swappable batteries as an expansion, providing both convenient battery replacement and increased overall capacity or voltage.

A first aspect of the present disclosure provides a battery system configured for an electric vehicle. The battery system includes a first battery module, a second battery module, and a switch device. The second battery module is configured to accommodate multiple swappable batteries. The switch device is coupled to the first battery module and the second battery module, and configured to switch a first connection configuration between the first battery module and the second battery module, and to switch a second connection configuration between the swappable batteries when switching the first connection configuration, where each of the first connection configuration and the second connection configuration includes a series connection and a parallel connection.

In some implementations of the first aspect, the switch device is configured to switch the second connection configuration to the series connection when switching the first connection configuration to the parallel connection.

In some implementations of the first aspect, the switch device is configured to switch the second connection configuration to the parallel connection when switching the first connection configuration to the series connection.

In some implementations of the first aspect, the electric vehicle includes a power conversion device. The power conversion device is configured to provide energy to a motor of the electric vehicle. The switch device is further configured to be coupled between the first battery module, the second battery module, and the power conversion device. The switch device includes a first switch circuit and a second switch circuit. The first switch circuit is coupled to the second battery module and is configured to switch the second connection configuration. The second switch circuit is coupled to the first battery module, the first switch circuit, and the power conversion device, and is configured to switch the first connection configuration.

In some implementations of the first aspect, the first switch circuit includes multiple switch circuit units. Each switch circuit unit includes a first input point and a second input point and is configured to connect two swappable batteries of the multiple swappable batteries. The first input point is configured to connect a first electrode of a first one of the two swappable batteries, and the second input point is configured to connect a second electrode of a second one of the two swappable batteries. The first switch circuit also includes a first output terminal and a second output terminal. When the second connection configuration is in the series connection, each switch circuit unit is configured to connect the first electrode of the first one of the two swappable batteries to the second electrode of the second one of the two swappable batteries. When the second connection configuration is in the parallel connection, each switch circuit unit is configured to connect the first electrode of the first one of the two swappable batteries to the first output terminal and connect the second electrode of the second one of the two swappable batteries to the second output terminal.

In some implementations of the first aspect, the second switch circuit includes a second switch circuit unit, the second switch circuit unit includes a first input point and a second input point. The first input point of the second switch circuit is configured to connect to a first electrode of the first battery module, and the second input point of the second switch circuit is configured to connect to an output of the first switch circuit unit corresponding to a second electrode. The second switch circuit further includes a first output terminal and a second output terminal which are configured to connect to the power conversion device. When the first connection configuration is in the series connection, the switch circuit unit is configured to connect the first electrode of the first battery module to the output of the first switch circuit unit corresponding to the second electrode. When the first connection configuration is in the parallel connection, the switch circuit unit is configured to connect the first electrode of the first battery module to the first output terminal, and to connect the output of the first switch circuit unit corresponding to the second electrode to the second output terminal.

In some implementations of the first aspect, the switch device switches the first connection configuration to the parallel connection in a case that a required torque of the electric vehicle is greater than a torque threshold.

In some implementations of the first aspect, the switch device further switches the first connection configuration to the series connection in a case that the required torque of the electric vehicle is not greater than the torque threshold and a required rotational speed of the electric vehicle is greater than a speed threshold.

A second aspect of the present disclosure provides a power control system configured for an electric vehicle. The power control system includes a switch device and a power control unit. The switch device is configured to couple a first battery module and a second battery module, where the second battery module is configured to accommodate multiple swappable batteries. The power control unit is coupled to the switch device and configured to determine a connection configuration between the first battery module and the second battery module. The switch device is configured to switch a first connection configuration between the first battery module and the second battery module based on the connection configuration determined by the power control unit, and to switch a second connection configuration between the multiple swappable batteries when switching the first connection configuration, where each of the first connection configuration and the second connection configuration includes a series connection and a parallel connection.

In some implementations of the second aspect, the switch device is configured to switch the second connection configuration to the series connection when switching the first connection configuration to the parallel connection.

In some implementations of the second aspect, the switch device is configured to switch the second connection configuration to the parallel connection when switching the first connection configuration to the series connection.

In some implementations of the second aspect, the electric vehicle includes a power conversion device for providing energy to a motor of the electric vehicle. The switch device is further configured to be coupled between the first battery module, the second battery module, and the power conversion device. The switch device includes a first switch circuit and a second switch circuit. The first switch circuit is coupled to the second battery module and configured to switch the second connection configuration. The second switch circuit is coupled to the first battery module, the first switch circuit, and the power conversion device, and configured to switch the first connection configuration.

In some implementations of the second aspect, the first switch circuit includes multiple switch circuit units, each of the multiple switch circuit units includes a first input point and a second input point and is configured to connect two swappable batteries of the multiple swappable batteries. The first input point is configured to connect a first electrode of a first one of the two swappable batteries, and the second input point is configured to connect the second electrode of a second one of the two swappable batteries. The first switch circuit also includes a first output terminal and a second output terminal. When the second connection configuration is in the series connection, each switch circuit unit is configured to connect the first electrode of the first one of the two swappable batteries to the second electrode of the second one of the two swappable batteries. When the second connection configuration is in the parallel connection, each switch circuit unit is configured to connect the first electrode of the first one of the two swappable batteries to the first output terminal, and to connect the second electrode of the second one of the two swappable batteries to the second output terminal.

In some implementations of the second aspect, the second switch circuit includes a second switch circuit unit, the second switch circuit unit includes a first input point and a second input point. The first input point of the second switch circuit is configured to connect to a first electrode of the first battery module, and the second input point of the second switch circuit is configured to connect to an output of the first switch circuit unit corresponding to the second electrode. The second switch circuit further includes a first output terminal and a second output terminal which are configured to connect to the power conversion device. When the first connection configuration is in the series connection, the switch circuit unit is configured to connect the first electrode of the first battery module to the output of the first switch circuit unit corresponding to the second electrode. When the first connection configuration is in the parallel connection, the switch circuit unit is configured to connect the first electrode of the first battery module to the first output terminal, and to connect the output of the first switch circuit unit corresponding to the second electrode to the second output terminal.

In some implementations of the second aspect, the power control system determines the connection configuration to the parallel connection in a case that the required torque of the electric vehicle is greater than a torque threshold.

In some implementations of the second aspect, the power control system determines the connection configuration to the series connection in a case that the required torque of the electric vehicle is not greater than the torque threshold and the required rotational speed of the electric vehicle is greater than a speed threshold.

The third aspect of the present disclosure provides a control method for a battery system. The battery system includes a first battery module and a second battery module configured to accommodate multiple swappable batteries. The control method includes: determining a connection configuration between the first battery module and the second battery module; switching a first connection configuration between the first battery module and the second battery module based on the determined connection configuration; and switching a second connection configuration between the multiple swappable batteries when switching the first connection configuration between the first and the second battery modules. Each of the first connection configuration and the second connection configuration includes a series connection and a parallel connection.

In some implementations of the third aspect, switching the second connection configuration between the multiple swappable batteries includes: switching the second connection configuration between the multiple swappable batteries to the series connection when switching the first connection configuration to the parallel connection.

In some implementations of the third aspect, switching the second connection configuration between the multiple swappable batteries includes: switching the second connection configuration between the multiple swappable batteries to the parallel connection when switching the first connection configuration to the series configuration.

In some implementations of the third aspect, the battery system is adapted to an electric vehicle, and determining the connection configuration between the first battery module and the second battery module includes: acquiring a required torque of the electric vehicle; determining whether the required torque is greater than a torque threshold; and in a case that the required torque is greater than the torque threshold, determining that the connection configuration between the first battery module and the second battery module is the parallel connection.

In some implementations of the third aspect, determining the connection configuration between the first battery module and the second battery module further includes: acquiring a required rotational speed of the electric vehicle; determining whether the required rotational speed is greater than a rotational speed threshold; and in a case that the required torque is not greater than the torque threshold and that the required rotational speed is greater than the rotational speed threshold, determining that the connection configuration between the first battery module and the second battery module is the series connection.

Based on the above, the power control system, battery system, and control method proposed in the present disclosure use the swappable battery-compatible second battery module as an expansion, providing both convenient battery replacement and increased overall capacity or voltage. In addition, the circuit of the switch device for switching the connection configuration between the first and second battery modules is designed to avoid unrealistic voltage range requirements of the power conversion device behind it, and can also extend the life of the battery module.

### BRIEF DESCRIPTION OF THE DRAWINGS

FIG. 1 illustrates a block diagram of a battery system in an implementation of the present disclosure.

FIG. 2 illustrates a block diagram of a battery system in another implementation of the present disclosure.

FIG. 3 illustrates a block diagram of a switch device in an implementation of the present disclosure.

FIG. 4 illustrates a schematic diagram of a first battery module and a second battery module connected in series connection in an implementation of the present disclosure.

FIG. 5 illustrates a schematic diagram of a first battery module and a second battery module connected in parallel connection in an implementation of the present disclosure.

FIG. 6 illustrates a flowchart of a control method for a battery system in an implementation of the present disclosure.

### DETAILED DESCRIPTION

The following will refer to the relevant drawings to describe implementations of a battery system for an electric vehicle in the present disclosure, in which the same components will be identified by the same reference symbols.

The following description includes specific information regarding the exemplary implementations of the present disclosure. The accompanying detailed description and drawings of the present disclosure are intended to illustrate the exemplary implementations only. However, the present disclosure is not limited to these exemplary implementations. Those skilled in the art will appreciate that various modifications and alternative implementations of the present disclosure are possible. In addition, the drawings and examples in the present disclosure are generally not drawn to scale and do not correspond to actual relative sizes.

The term “couple” is defined as a connection, whether direct or indirect, through an intermediate component, and is not necessarily limited to a physical connection. When the terms “comprising” or “including” are used, they mean “including but not limited to,” and explicitly indicate an open relationship between the combination, group, series, and the like.

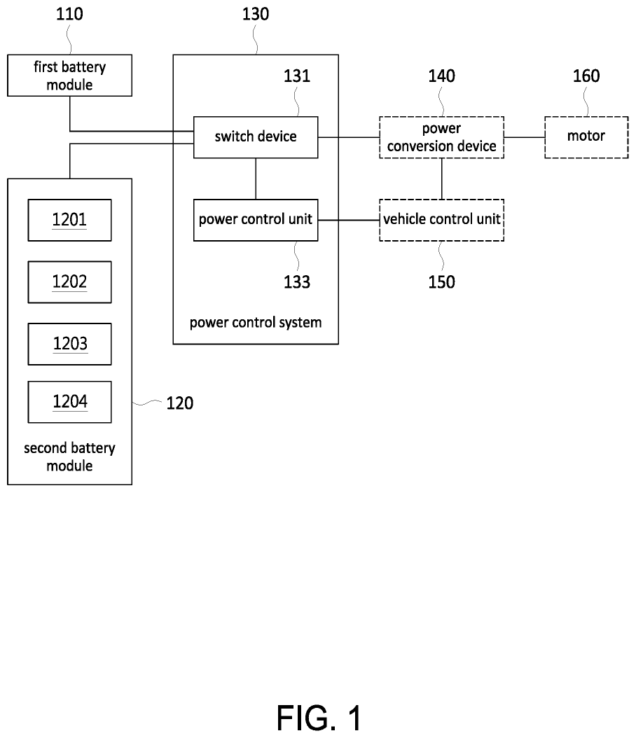

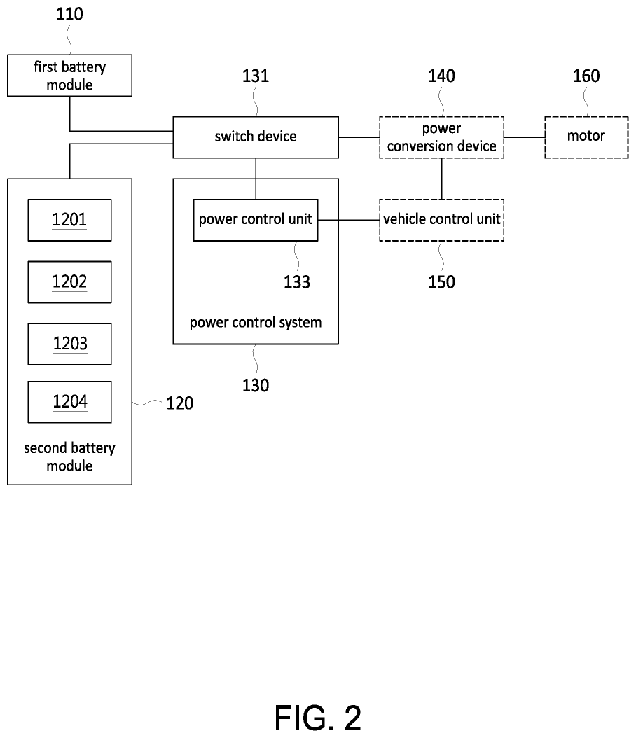

FIG. 1 illustrates a block diagram of a battery system in an implementation of the present disclosure; FIG. 2 illustrates a block diagram of a battery system in another implementation of the present disclosure.

Referring to FIGS. 1 and 2, a battery system of an electric vehicle (EV) may include a first battery module 110, a second battery module 120, and a switch device 131. The switch device 131 may be coupled to the first battery module 110 and the second battery module 120, and be configured to switch the connection configuration (also referred to as the first connection configuration in this application) between the first battery module 110 and the second battery module 120.

Specifically, the first battery module 110 and the second battery module 120 may be configured to store and provide the energy required by the electric vehicle. Depending on the different voltage or current requirements of the electric vehicle, the switch device 131 may switch the first connection configuration between the first battery module 110 and the second battery module 120. In some implementations, when the electric vehicle requires a higher voltage, the switch device 131 may connect the first battery module 110 and the second battery module 120 to series connection; when the electric vehicle requires a larger current, the switch device 131 may connect the first battery module 110 and the second battery module 120 to parallel connection. In some implementations, the switch device 131 may also choose to use only the first battery module 110 or the second battery module 120 to provide the energy required by the electric vehicle.

It should be noted that the term “electric vehicle” mentioned in this application may refer to any vehicle that at least partially uses stored electrical energy as a power source, and may not be limited to cars or motorcycles that travel on land. It may also include boats that travel on water or airplanes that fly in the air.

Returning to FIGS. 1 and 2, the switch device 131 may be coupled between the first battery module 110, the second battery module 120, and the power conversion device 140, to connect the first battery module 110 and the second battery module 120 to series or parallel connection to the power conversion device 140. In some implementations, the power conversion device 140 may be configured to convert the energy from the first battery module 110 and second battery module 120 into a form suitable for the motor 160 of the electric vehicle and provide it to the motor 160. For example, the power conversion device 140 may be an inverter that converts the direct current (DC) from the first battery module 110 and the second battery module 120 into alternating current (AC) and supplies it to the motor 160.

In some implementations, the switch device 131 may be integrated into the power control system 130, as shown in FIG. 1. In such cases, the power control system 130 may include the switch device 131 and a power control unit (PCU) 133 which is coupled to the switch device 131. The power control unit 133 may be configured to receive signals from the vehicle control unit (VCU) 150, and based on the received signals, determine the connection configuration (e.g., but not limited to, to series connection or to parallel connection) between the first battery module 110 and the second battery module 120, and then control the switch device 131 accordingly. In some implementations, although not shown in FIG. 1, the power control system 130 may further include other components such as a battery management system (BMS), voltage regulation circuitry, and the like, the present disclosure is not limited thereto.

In some implementations, the switch device 131 may be independent from the power control system 130, as shown in FIG. 2. In such case, the power control system 130 may include a power control unit 133. The power control unit 133 may be coupled to an external switch device 131, and configured to receive signals from the vehicle control unit 150 and determine the connection configuration between the first battery module 110 and the second battery module 120 (e.g., but not limited to, to series connection or to parallel connection), and then control the switch device 131 accordingly. In some implementations, although not shown in FIG. 2, the power control system 130 may also include other components such as a Battery Management System (BMS), voltage regulation circuit, and the like, the present disclosure is not limited to these.

In some implementations, signals from the vehicle control unit 150 may include at least one of the required torque and the required rotational speed of the electric vehicle. For example, the required torque of the electric vehicle may be determined by the speed at which the driver depresses the accelerator pedal, and the required rotational speed may be determined by the depth of the accelerator pedal or the motor 160 of the electric vehicle, the present disclosure is not limited thereto.

In some implementations, the first battery module 110 may include a first type of battery, which is typically larger in volume, weight, and voltage. For example, the first type of battery may be a lead-acid battery, a nickel-hydrogen battery, a nickel-zinc battery, a nickel-cadmium battery, a lithium-ion battery, or the like, and can provide several hundred volts of voltage (e.g., 300 to 400 volts), but the present disclosure is not limited thereto. In addition, in order to achieve an acceptable storage capacity, the first type of battery used in electric vehicles often weighs several hundred kilograms (e.g., 300 to 400 kilograms), making it difficult to replace. Once the remaining power is insufficient, it is necessary to spend a lot of time at a charging station to charge it. To solve the above problems and further improve the convenience of electric vehicles and the flexibility of battery configuration, the battery system of the present disclosure further includes a second battery module 120.

In some implementations, the second battery module 120 may be configured to accommodate multiple swappable batteries, which are, for example, a second type of battery. The second type of battery, for example, may be a heterogeneous battery compared to the first type of battery, featuring smaller volume, weight and voltage. For example, the second type of battery may be a lithium battery, a solid-state battery, each providing tens of volts of voltage (e.g., 30 to 50 volts) and weighing a few kilograms (e.g., 9 kilograms), but the present disclosure is not limited thereto. Advantageously, based on the above characteristics of the second type of battery and the current prevalence of battery swapping stations of the second type of battery, users can more easily and conveniently replace the swappable batteries in the second battery module 120.

In some implementations, the second battery module 120 may include multiple slots 1201-1204 that are compatible with swappable batteries. Each of the slots 1201-1204 may be coupled to a switch device 131, and the switch device 131 may switch the connection configuration (also referred to as the second connection configuration) between multiple swappable batteries in the multiple slots 1201-1204.

In addition, it should be noted that although four slots 1201-1204 are shown in the drawings as being located in the second battery module 120, those skilled in the art should understand that the second battery module 120 can also include two, three, or more than four slots. The present disclosure does not limit the number of slots in the second battery module 120.

Advantageously, the addition of the second battery module 120 may also further enhance the performance of the electric vehicle. For example, when the first battery module 110 is connected in series connection with the second battery module 120, the output voltage can be increased to drive the motor 160 to a higher rotational speed, and when the first battery module 110 is connected in parallel connection with the second battery module 120, the output current can be increased to achieve a higher torque.

In some implementations, the power control unit 133 may determine whether the required torque of the electric vehicle is greater than a torque threshold based on signals from the vehicle control unit 150. If so, it is determined that the connection configuration between the first battery module 110 and the second battery module 120 is in parallel connection, to provide a higher current. On the other hand, if it is determined that the required torque of the electric vehicle is not greater than the torque threshold, the power control unit 133 may determine whether the required rotational speed of the electric vehicle is greater than a rotational speed threshold based on signals from the vehicle control unit 150. If so, it is determined that the connection configuration between the first battery module 110 and the second battery module is in series connection, to provide a higher voltage.

In some implementations, the power control unit 133 may determine whether the required rotational speed of the electric vehicle is greater than the rotational speed threshold based on signals from the vehicle control unit 150. If so, the power control unit 133 may determine that the connection configuration between the first battery module 110 and the second battery module 120 is in series connection to provide a higher voltage. On the other hand, if the required rotational speed of the electric vehicle is not greater than the rotational speed threshold, the power control unit 133 may determine whether the required torque of the electric vehicle is greater than the torque threshold based on signals from the vehicle control unit 150. If so, the power control unit 133 may determine that the connection configuration between the first battery module 110 and the second battery module 120 is in parallel connection to provide a higher current.

However, if the voltage difference between the two battery modules is too large during parallel connection, the current may reverse and surge back to the battery module with lower voltage, causing malfunctions or even explosions. On the other hand, the input voltage range of electronic devices usually has its limitations, so it is necessary to control the final output voltage well when two battery modules are connected in series connection, in order to avoid exceeding the load range of the power conversion device. To address the above problem, implementations of the disclosure have designed a solution through a switch device 131.

In some implementations, the switch device 131 may be configured to switch the first connection configuration between the first battery module and the second battery module, and also switch the second connection configuration between swappable batteries within the second battery module 120 when switching the first connection configuration between the first battery module 110 and the second battery module 120.

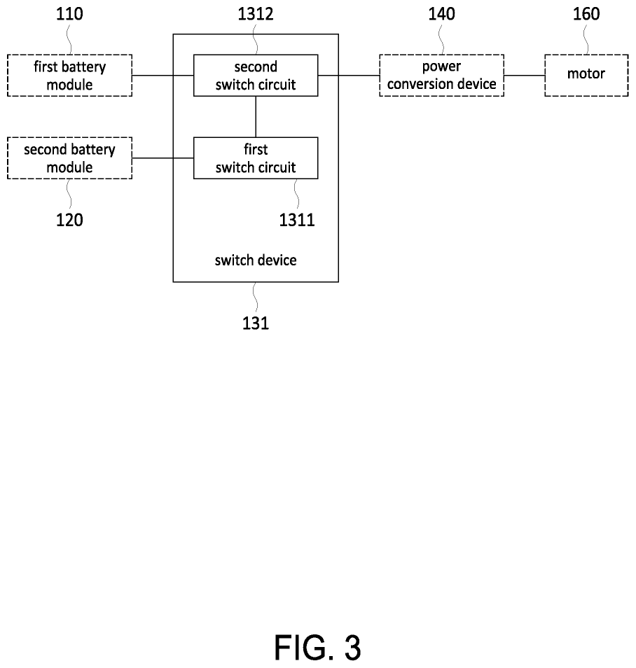

FIG. 3 illustrates a block diagram of the switch device in an implementation of the present disclosure.

Referring to FIG. 3, the switch device 131 may include a first switch circuit 1311 and a second switch circuit 1312. The first switch circuit 1311 may be coupled to the second battery module 120 for switching the connection configuration between multiple slots in the second battery module 120, thereby switching the second connection configuration between the swappable batteries. The second switch circuit 1312 may be coupled between the first battery module 110, the first switch circuit 1311, and the power conversion device 140, for switching the first connection configuration between the first battery module 110 and the second battery module 120.

In some implementations, the switch device 131 is configured to switch the second connection configuration to series connection when switching the first connection configuration to parallel connection. Specifically, when the first switch circuit 1311 connects the first battery module 110 to parallel connection with the second battery module 120, the second switch circuit 1312 may cause the multiple swappable batteries in the second battery module 120 to be connected to series connection with each other. This can effectively prevent reverse current surge situations.

For example, the first battery module 110 provides a voltage of 400V, and the second battery module 120 is equipped with 10 swappable batteries with a voltage of 40V each. In this case, if the first battery module 110 is connected to parallel connection with the second battery module 120 and the swappable batteries in the second battery module 120 are also connected to parallel connection with each other, a fault may occur in the swappable batteries due to the excessive voltage difference between the output voltage of the first battery module 110 (e.g., 400V) and the output voltage of the second battery module 120 (e.g., 40V). Therefore, when the second switch circuit 1312 connects the first battery module 110 to parallel connection with the second battery module 120, the first switch circuit 1311 will connect the swappable batteries in the second battery module 120 to series connection with each other to reduce the voltage difference between the output voltage of the first battery module 110 (e.g., 400V) and the output voltage of the second battery module 120 (e.g., 40V). In this case, the total output voltage is about 400V.

In some implementations, a first DC transformer may be provided between the first battery module 110 and the second switch circuit 1312. The first DC transformer may be configured to receive signals from the battery management system corresponding to the first battery module 110 and adjust the output voltage of the first battery module 110 as needed. This can further effectively prevent reverse current surge situations.

In some implementations, a second DC transformer may be provided between the second battery module 120 and the first switch circuit 1311. The second DC transformer may be configured to receive signals from the battery management system corresponding to the second battery module 120 and adjust the output voltage of the second battery module 120 as needed. This can further effectively prevent reverse current surge situations.

In some implementations, both the first DC transformer and the second DC transformer may coexist and communicate with each other to adjust the voltage difference between the output voltage of the first battery module 110 and the second battery module 120.

In some implementations, the switch device 131 may be configured to switch the second connection configuration to parallel connection when switching the first connection configuration to series connection. In other words, when the first battery module 110 is connected to series connection with the second battery module 120, multiple swappable batteries in the second battery module 120 may be connected to parallel connection with each other. Accordingly, the voltage range of the final output to the power conversion device 140 can be effectively controlled.

For example, the first battery module 110 provides a voltage of 400V, and the second battery module 120 is equipped with 10 swappable batteries with a voltage of 40V each. As described above, when the switch device 131 connects the first battery module 110 and the second battery module 120 to parallel connection, the total output voltage is about 400V. In this case, if the first battery module 110 is connected to series connection with the second battery module 120, and the swappable batteries in the second battery module 120 are also connected to series connection with each other, the total output voltage will reach 800V. As a result, the power conversion device 140 needs an input voltage range at least from 400V to 800V, which is not practical. Therefore, when the second switch circuit 1312 connects the first battery module 110 and the second battery module 120 to series connection, the first switch circuit 1311 may connect the swappable batteries in the second battery module 120 to parallel connection with each other to reduce the overall total output voltage (e.g., 440V), and to reduce the input voltage range required by the power conversion device 140 (e.g., from 400V to 440V).

In some implementations, the switch device 131 may be controlled by, for example, signals received from the power control unit 133. However, the present disclosure is not limited thereto. In some implementations, the switch device 131 may be controlled by, for example, signals received from other devices such as the vehicle control unit 150 or the battery management system.

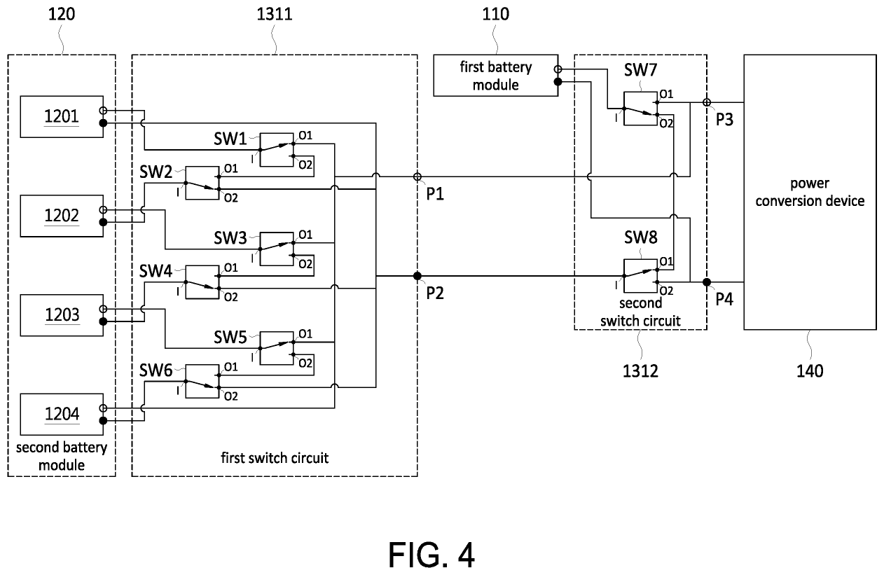

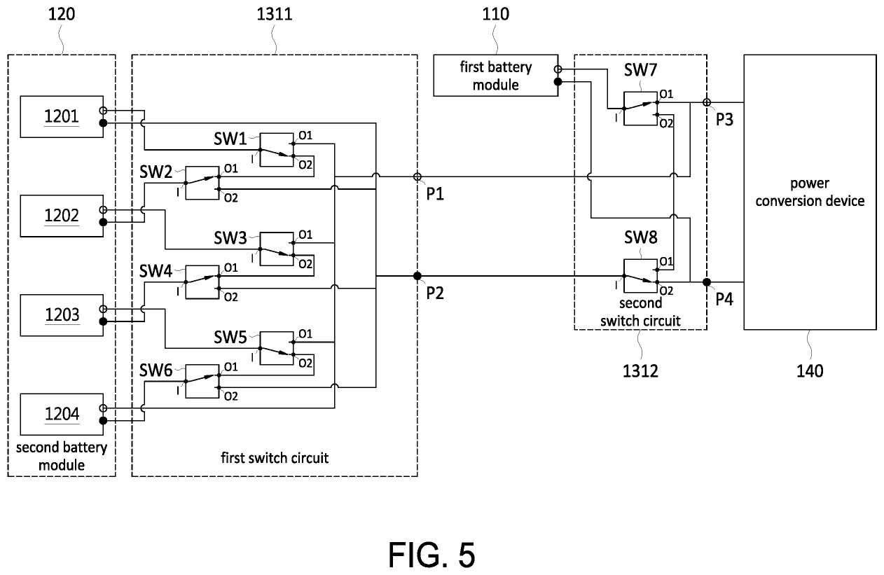

Next, with reference to FIG. 4 and FIG. 5, further examples will be provided to illustrate the switch device 131 designed in the implementations of the present disclosure.

FIG. 4 illustrates a schematic diagram of the first battery module and the second battery module connected to series connection in an implementation of the present disclosure; FIG. 5 illustrates a schematic diagram of the first battery module and the second battery module connected to parallel connection in an implementation of the present disclosure.

In FIGS. 4 and 5, the first electrode and the second electrode are represented by white dots and black dots, respectively, where the first electrode and second electrode are not the same. In other words, the first electrode can be an anode and the second electrode can be a cathode. Alternatively, the first electrode can be a cathode and the second electrode can be an anode.

Referring to FIGS. 4 and 5. The first switch circuit 1311 may include multiple switch circuit units, and each switch circuit unit may be configured to connect two swappable batteries of the multiple swappable batteries: when the second connection configuration is in series connection, connecting the first electrode of the first one of the two swappable batteries to the second electrode of the second one of the two swappable batteries; and when the second connection configuration is in parallel connection, connecting the first electrode of the first one of the two swappable batteries to the first output P1 of the first switch circuit unit 1311 (e.g., corresponding to the first electrode), and connecting the second electrode of the second one of the two swappable battery to the second output P2 of the first switch circuit unit 1311 (e.g., corresponding to the second electrode).

For example, the first switch circuit unit includes switches SW1 and SW2 and is configured to connect the swappable batteries in slots 1201 and 1202. The input point I of switch SW1 (e.g., the first input of the first switch circuit unit) is connected to the first electrode of the swappable battery in slot 1201, and the input point I of switch SW2 (e.g., the second input of the first switch circuit unit) is connected to the second electrode of the swappable battery in slot 1202. The first switch circuit unit, when the first connection configuration is in parallel connection and the second connection configuration is in series connection, connects the first electrode of the swappable battery in slot 1201 to the second electrode of the swappable battery in slot 1202, as shown in FIG. 5; and, when the first connection configuration is in series connection and the second connection configuration is in parallel connection, connects the first electrode of the swappable battery in slot 1201 to the first output terminal P1 of the first switch circuit 1311, and connects the second electrode of the swappable battery in slot 1202 to the second output terminal P2 of the first swappable circuit 1311, as shown in FIG. 4.

For example, the second switch circuit unit includes switches SW3 and SW4 and is configured to connect the swappable batteries in slots 1202 and 1203. The input point I of switch SW3 (e.g., the first input of the second switch circuit unit) is connected to the first electrode of the swappable battery in slot 1202, and the input point I of switch SW4 (i.e., the second input of the second switch circuit unit) is connected to the second electrode of the swappable battery in slot 1203. The second switch circuit unit, when the first connection configuration is in parallel connection and the second connection configuration is in series connection, connects the first electrode of the swappable battery in slot 1202 to the second electrode of the swappable battery in slot 1203, as shown in FIG. 5; and, when the first connection configuration is in series connection and the second connection configuration is in parallel connection, connects the first electrode of the swappable battery in slot 1202 to the first output terminal P1 of the first switch circuit 1311, and connects the second electrode of the swappable battery in slot 1203 to the second output terminal P2 of the first switch circuit 1311, as shown in FIG. 4.

For example, the third switch circuit unit includes switches SW5 and SW6 and is configured to connect the swappable batteries in slots 1203 and 1204. The input point I of switch SW5 (e.g., the first input of the third switch circuit unit) is connected to the first electrode of the swappable battery in slot 1203, and the input point I of switch SW6 (e.g., the second input of the third switch circuit unit) is connected to the second electrode of the swappable battery in slot 1204. The third switch circuit unit, when the first connection configuration is in parallel connection and the second connection configuration is in series connection, connects the first electrode of the swappable battery in slot 1203 to the second electrode of the swappable battery in slot 1204, as shown in FIG. 5; and, when the first connection configuration is in series connection and the second connection configuration is in parallel connection, connects first electrode of the swappable battery in slot 1203 to the first output terminal P1 of the first switch circuit 1311 and connects the second electrode of the swappable battery in slot 1204 to the second output terminal P2 of the first switch circuit unit 1311, as shown in FIG. 4.

In some implementations, each switch SW1-SW6 may include at least an input point I, a first output point O1, and a second output point O2. The input point I may be selectively connected to either the first output point O1 or the second output point O2.

Specifically, the first electrode of slot 1201 may be connected to the input point I of switch SW1, the second electrode of slot 1201 may be connected to the second output terminal P2 of the first switch circuit 1311; the first electrode of slot 1202 may be connected to the input point I of switch SW3, the second electrode of slot 1202 may be connected to the input point I of switch SW2; the first electrode of slot 1203 may be connected to the input point I of switch SW5, and the second electrode of slot 1203 may be connected to the input point I of switch SW4; the first electrode of slot 1204 may be connected to the first output terminal P1 of the first switch circuit 1311, the second electrode of slot 1204 may be connected to the input point I of switch SW6. In addition, the first output points O1 of switches SW1, SW3, and SW5 are connected to each other and connected to the first output terminal P1 of the first switch circuit 1311 corresponding to the first electrode, the second output points O2 of switches SW1, SW3, and SW5 are respectively connected to the first output points O1 of switches SW2, SW4, and SW6, and the second output points O2 of switches SW2, SW4, and SW6 are connected to each other and connected to the second output terminal P2 of the first switch circuit 1311 corresponding to the second electrode.

As shown in FIG. 4, when the first connection configuration is in series and the second connection configuration is in parallel connection, the input points I of switches SW1, SW3, and SW5 are connected to the second output points O2 thereof, and the input points I of switches SW2, SW4, and SW6 are connected to the first output points O1 thereof. Therefore, the swappable batteries in slots 1201, 1202, 1023, and 1204 are connected in parallel connection, and the first output terminal P1 and the second output terminal P2 of the first switch circuit 1311 correspond respectively to the first electrode and the second electrode.

As shown in FIG. 5, when the first connection configuration is in parallel connection and the second connection configuration is in series connection, the input points I of switches SW1, SW3, and SW5 are connected to the second output points O2 thereof, and the input points I of switches SW2, SW4, and SW6 are connected to the first output points O1 thereof. Therefore, the swappable batteries in slots 1201, 1202, 1023, and 1204 are connected in series connection, and the first output terminal P1 and the second output terminal P2 of the first switch circuit 1311 correspond respectively to the first electrode and the second electrode.

Referring to FIGS. 4 and 5, the second switch circuit 1312 may include at least one switch circuit unit, and may be configured to connect the first battery module 110 and the first switch circuit 1311: when the first connection configuration is in series connection, connecting the first electrode of the first battery module 110 to the second output terminal P2 of the first switch circuit 1311 corresponding to the second electrode; and when the first connection configuration is in parallel connection, connecting the first electrode of the first battery module 110 to the first output terminal P3 of the second switch circuit 1312 (e.g., corresponding to the first electrode), and connecting the second output terminal P2 of the first switch circuit 1311 corresponding to the second electrode to the second output terminal P4 of the first switch circuit 1311 (e.g., corresponding to the second electrode).

For example, the fourth switch circuit unit includes switches SW7 and SW8, where the input point I of switch SW7 (e.g., the first input point of the fourth switch circuit unit) is connected to the first electrode of the first battery module 110, and the input point I of switch SW8 (e.g., the second input point of the fourth switch circuit unit) is connected to the second output terminal P2 of the first switch circuit 1311 corresponding to the second electrode. When the first connection configuration is in series connection, as shown in FIG. 4, the fourth switch circuit unit connects the first electrode of the first battery module 110 to the second output terminal P2 of the first switch circuit 1311 corresponding to the second electrode. When the first connection configuration is in parallel connection, as shown in FIG. 5, the fourth switch circuit unit connects the first electrode of the first battery module 110 to the first output terminal P3 of the second switch circuit 1312, and connects the second output terminal P2 of the first switch circuit 1311 corresponding to the second electrode to the second output terminal P4 of the second switch circuit 1312.

In some implementations, each of the switch SW7 and SW8 may include at least an input point I, a first output point O1, and a second output point O2, and the input point I may be selectively connected to either the first output point O1 or the second output point O2.

Specifically, the first electrode of the first battery module 110 may be connected to the input point I of switch SW7, and the second electrode of the first battery module 110 may be connected to the second output terminal P4 of the second switch circuit 1312; the first output terminal P1 of the first switch circuit 1311 corresponding to the first electrode may be connected to the first output terminal P3 of the second switch circuit 1312, and the second output terminal P2 of the first switch circuit 1311 corresponding to the second electrode may be connected to the input point I of switch SW8. In addition, the first output point O1 of switch SW7 may be connected to the first output terminal P3 of the second switch circuit 1312 corresponding to the first electrode, the second output point O2 of switch SW7 may be connected to the first output point O1 of switch SW8, and the second output point O2 of switch SW8 may be connected to the second output terminal P4 of the second switch circuit 1312 corresponding to the second electrode.

As shown in FIG. 4, when the first connection configuration is in series connection, the input point I of switch SW7 is connected to the second output point O2 thereof, and the input point I of switch SW8 is connected to the first output point O1 thereof. Therefore, the first battery module 110 is connected in series connection with the first switch circuit 1311. Overall, the first battery module 110 is connected in series connection with the second battery module 120, and the first output terminal P3 and the second output terminal P4 of the second switch circuit 1312 respectively correspond to the first electrode and the second electrode of the overall output.

As shown in FIG. 5, when the first connection configuration is in parallel connection, the input point I of switch SW7 is connected to the first output point O1 thereof, and the input point I of switch SW8 is connected to the second output point O2 thereof. Therefore, the first battery module 110 is connected in parallel connection with the first switch circuit 1311. Overall, the first battery module 110 is connected in parallel connection with the second battery module 120, and the first output terminal P3 and the second output terminal P4 of the second switch circuit 1312 respectively correspond to the first electrode and the second electrode of the overall output.

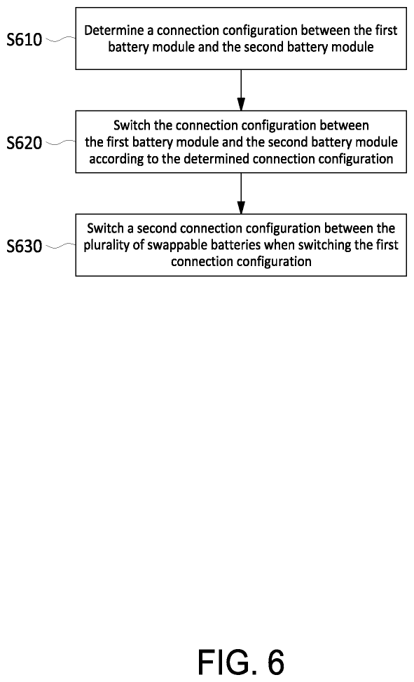

FIG. 6 illustrates a flowchart of a control method for a battery system in an implementation of the present disclosure. The control method described herein is applicable to the battery system introduced with reference to FIGS. 1 to 5. The following are the detailed steps of the control method, accompanied by an explanation of each component in the battery system.

Referring to FIG. 6, in step S610, determine a connection configuration between the first battery module 110 and the second battery module 120.

Specifically, step S610 may determine the first battery module 110 and the second battery module 120 are connected in series connection, parallel connection, or to use only the first battery module 110 or the second battery module 120.

In some implementations, the determination in step S610 may be made by the power control unit 133. For example, the power control unit 133 may obtain information such as the rotational speed of motor 160 and driver intent (such as pedal force or speed) from the vehicle control unit 150, and based on the obtained information, determine the connection configuration between the first battery module 110 and the second battery module 120.

In some implementations, the power control unit 133 may obtain the required torque of the electric vehicle from the vehicle control unit 150 and accordingly determine whether it is greater than a torque threshold. If so, the power control unit 133 may determine to connect the first battery module 110 and the second battery module 120 in parallel connection to provide a higher current. On the other hand, if the required torque of the electric vehicle is determined to be not greater than the torque threshold, the power control unit 133 may obtain the required rotational speed of the electric vehicle from the vehicle control unit 150 and accordingly determine whether it is greater than a rotational speed threshold. If so, the power control unit 133 may determine to connect the first battery module 110 and the second battery module 120 in series connection to provide a higher voltage.

In some implementations, the power control unit 133 may obtain the required rotational speed of the electric vehicle from the vehicle control unit 150 and accordingly determine whether it is greater than the rotational speed threshold. If so, the power control unit 133 may determine to connect the first battery module 110 and the second battery module 120 in series connection to provide a higher voltage. On the other hand, if the required rotational speed of the electric vehicle is determined to be not greater than the rotational speed threshold, the power control unit 133 may obtain the required torque of the electric vehicle from the vehicle control unit 150 and accordingly determine whether it is greater than the torque threshold. If so, the power control unit 133 may determine to connect the first battery module 110 and the second battery module 120 in parallel connection to provide a higher current.

In some implementations, the power control unit 133 may obtain the required rotational speed and torque of the electric vehicle from the vehicle control unit 150 and further determine to connect the first battery module 110 and the second battery module 120 in series connection, parallel connection, or to use only the first battery module 110 or the second battery module 120 based on default rules.

For example, the default rules may be presented as in Table 1 below. In which, the rotational speed is divided into a plurality (e.g., three) of intervals, and the torque is divided into a plurality (e.g., three) of intervals. After obtaining the required rotational speed and torque of the electric vehicle in the power control unit 133, the first battery module 110 and the second battery module 120 may be connected in series connection, parallel connection, or to use only the first battery module 110 or the second battery module 120 according to the default rules.

TABLE 1

| | Rotational speed | Rotational speed | Rotational speed |
|---|---|---|---|
| | Interval 1 | Interval 2 | Interval 3 |
| Torque Interval 1 | Second battery module | First battery module | First battery module |
| Torque Interval 2 | First battery module | First battery module | Series connection |
| Torque Interval 3 | Parallel connection | Parallel connection | Parallel connection |

It should be noted that the present disclosure is not limited to the specific method of determining the connection configuration between the first battery module 110 and the second battery module 120.

In some implementations, the determination in step S610 may be made by the battery management system or the vehicle control unit, the present disclosure is not limited thereto.

In step S620, the switch device 131 may switch the connection configuration between the first battery module 110 and the second battery module 120 according to the connection configuration determined in step S610.

Specifically, if the connection configuration determined in step S610 is to use only the first battery module 110 or only the second battery module 120, the switch device 131 may disconnect the connection of the other battery module accordingly. It should be noted that although the circuit structures for using only the first battery module 110 and only the second battery module 120 are not presented herein, those skilled in the art should be able to easily modify the switch device 131 presented herein.

On the other hand, if the connection configuration determined in step S610 is to connect the first battery module 110 and the second battery module 120 in series connection or parallel connection, the switch device 131 may switch the first connection configuration between the first battery module 110 and the second battery module 120 accordingly.

In step S630, when the switch device 131 switches the first connection configuration between the first battery module 110 and the second battery module 120, it may also switch the second connection configuration between multiple swappable batteries in the second battery module 120.

Specifically, when the switch device 131 switches the first battery module 110 and the second battery module 120 to a series connection, it may switch the multiple swappable batteries in the second battery module 120 to a parallel connection; when the switch device 131 switches the first battery module 110 and the second battery module 120 to a parallel connection, it may switch multiple swappable batteries in the second battery module 120 to a series connection.

In summary, the power control system, battery system, and control method provided in the implementations of the present disclosure use the swappable battery-compatible second battery module as an expansion to improve the overall capacity or voltage while also facilitating battery replacement. In addition, the circuit of the switch device configured to switch the connection configuration between the first battery module and the second battery module is designed to avoid unrealistic high voltage range requirements for the downstream power conversion device and can extend the battery module's lifespan.

Based on the above description, it is apparent that various techniques can be configured to implement the concepts described in this application without departing from their scope. Furthermore, although certain implementations have been specifically described and illustrated, those skilled in the art will recognize that variations and modifications can be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions can be made within the scope of the present disclosure.

What is claimed is:

1. A battery system configured for an electric vehicle, comprising:
a first battery module;
a second battery module configured to accommodate a plurality of swappable batteries; and
a switch device coupled to the first battery module and the second battery module, the switch device is configured to switch a first connection configuration between the first battery module and the second battery module, and to switch a second connection configuration between the plurality of swappable batteries when switching the first connection configuration,
wherein each of the first connection configuration and the second connection configuration comprises a series connection and a parallel connection.

2. The battery system of claim 1, wherein the switch device is configured to switch the second connection configuration to the series connection when switching the first connection configuration to the parallel connection.

3. The battery system of claim 1, wherein the switch device is configured to switch the second connection configuration to the parallel connection when switching the first connection configuration to the series connection.

4. The battery system of claim 1, wherein the electric vehicle comprises a power conversion device for providing energy to a motor of the electric vehicle, the switch device is further configured to be coupled between the first battery module, the second battery module, and the power conversion device, and the switch device comprises:
a first switch circuit coupled to the second battery module and configured to switch the second connection configuration; and
a second switch circuit coupled to the first battery module, the first switch circuit, and the power conversion device, and configured to switch the first connection configuration.

5. The battery system of claim 4, wherein:
the first switch circuit comprises a plurality of switch circuit units, each of the plurality of switch circuit units comprises a first input point and a second input point and is configured to connect two swappable batteries of the plurality of swappable batteries,
the first input point is configured to connect a first electrode of a first one of the two swappable batteries, and the second input point is configured to connect a second electrode of a second one of the two swappable batteries,
the first switch circuit further comprises a first output terminal and a second output terminal,
when the second connection configuration is in the series connection, each of the plurality of switch circuit units is configured to connect the first electrode of the first one of the two swappable batteries to the second electrode of the second one of the two swappable batteries, and
when the second connection configuration is in the parallel connection, each of the plurality of switch circuit units is configured to connect the first electrode of the first one of the two swappable batteries to the first output terminal, and to connect the second electrode of the second one of the two swappable batteries to the second output terminal.

6. The battery system of claim 4, wherein:
the second switch circuit comprises a second switch circuit unit, the second switch circuit unit comprises a first input point and a second input point,
the first input point of the second switch circuit is configured to connect to a first electrode of the first battery module, and the second input point of the second switch circuit is configured to connect to an output of the first switch circuit unit corresponding to a second electrode,
the second switch circuit further comprises a first output terminal and a second output terminal which are configured to connect to the power conversion device,
when the first connection configuration is in the series connection, the switch circuit unit is configured to connect the first electrode of the first battery module to the output of the first switch circuit unit corresponding to the second electrode, and
when the first connection configuration is in the parallel connection, the switch circuit unit is configured to connect the first electrode of the first battery module to the first output terminal, and to connect the output of the first switch circuit unit corresponding to the second electrode to the second output terminal.

7. The battery system of claim 1, wherein the switch device switches the first connection configuration to the parallel connection in a case that a required torque of the electric vehicle is greater than a torque threshold.

8. The battery system of claim 7, wherein the switch device further switches the first connection configuration to the series connection in a case that the required torque of the electric vehicle is not greater than the torque threshold and a required rotational speed of the electric vehicle is greater than a speed threshold.

9. A power control system configured for an electric vehicle, comprising:
a switch device configured to couple a first battery module and a second battery module, the second battery module configured to accommodate a plurality of swappable batteries; and
a power control unit coupled to the switch device and configured to determine a connection configuration between the first battery module and the second battery module,
wherein the switch device is configured to switch a first connection configuration between the first battery module and the second battery module based on the connection configuration determined by the power control unit, and to switch a second connection configuration between the plurality of swappable batteries when switching the first connection configuration,
wherein each of the first connection configuration and the second connection configuration comprises a series connection and a parallel connection.

10. The power control system of claim 9, wherein the switch device is configured to switch the second connection configuration to the series connection when switching the first connection configuration to the parallel connection.

11. The power control system of claim 9, wherein the switch device is configured to switch the second connection configuration to the parallel connection when switching the first connection configuration to the series connection.

12. The power control system of claim 9, wherein the electric vehicle comprises a power conversion device for providing energy to a motor of the electric vehicle, the switch device is further configured to be coupled between the first battery module, the second battery module, and the power conversion device, and the switch device comprises:
a first switch circuit coupled to the second battery module and configured to switch the second connection configuration; and
a second switch circuit coupled to the first battery module, the first switch circuit, and the power conversion device, and configured to switch the first connection configuration.

13. The power control system of claim 12, wherein:
the first switch circuit comprises a plurality of switch circuit units, each of the plurality of switch circuit units comprises a first input point and a second input point and is configured to connect two swappable batteries of the plurality of swappable batteries,
the first input point is configured to connect a first electrode of a first one of the two swappable batteries, and the second input point is configured to connect a second electrode of a second one of the two swappable batteries,
the first switch circuit further comprises a first output terminal and a second output terminal,
when the second connection configuration is in the series connection, each of the plurality of switch circuit units is configured to connect the first electrode of the first one of the two swappable batteries to the second electrode of the second one of the two swappable batteries, and
when the second connection configuration is in the parallel connection, each of the plurality of switch circuit units is configured to connect the first electrode of the first one of the two swappable batteries to the first output terminal, and to connect the second electrode of the second one of the two swappable batteries to the second output terminal.

14. The power control system of claim 12, wherein:
the second switch circuit comprises a second switch circuit unit, the second switch circuit unit comprises a first input point and a second input point,
the first input point of the second switch circuit is configured to connect to a first electrode of the first battery module, and the second input point of the second switch circuit is configured to connect to an output of the first switch circuit unit corresponding to the second electrode,
the second switch circuit further comprises a first output terminal and a second output terminal which are configured to connect to the power conversion device,
when the first connection configuration is in the series connection, the switch circuit unit is configured to connect the first electrode of the first battery module to the output of the first switch circuit unit corresponding to the second electrode, and
when the first connection configuration is in the parallel connection, the switch circuit unit is configured to connect the first electrode of the first battery module to the first output terminal, and to connect the output of the first switch circuit unit corresponding to the second electrode to the second output terminal.

15. The power control system of claim 9, wherein the power control system determines the first connection configuration to the parallel connection in a case that a required torque of the electric vehicle is greater than a torque threshold.

16. The power control system of claim 15, wherein the power control system determines the first connection configuration to the series connection in a case that the required torque of the electric vehicle is not greater than the torque threshold and a required rotational speed of the electric vehicle is greater than a speed threshold.

17. A control method applicable in a battery system, the battery system comprising a first battery module and a second battery module configured to accommodate a plurality of swappable batteries, and the control method comprising:
determining a connection configuration between the first battery module and the second battery module;
switching a first connection configuration between the first battery module and the second battery module based on the determined connection configuration; and
switching a second connection configuration between the plurality of swappable batteries when switching the first connection configuration between the first and the second battery modules,
wherein each of the first connection configuration and the second connection configuration comprises a series connection and a parallel connection.

18. The control method of claim 17, wherein switching the second connection configuration between the plurality of swappable batteries comprises switching the second connection configuration between the plurality of swappable batteries to the series connection when switching the first connection configuration to the parallel connection.

19. The control method of claim 17, wherein switching the second connection configuration between the plurality of swappable batteries comprises switching the second connection configuration between the plurality of swappable batteries to the parallel connection when switch the first connection configuration to the series connection.

20. The control method of claim 17, wherein the battery system is adapted to an electric vehicle, and determining the connection configuration between the first battery module and the second battery module comprises:
acquiring a required torque of the electric vehicle;
determining whether the required torque is greater than a torque threshold; and
in a case that the required torque is greater than the torque threshold, determining that the connection configuration between the first battery module and the second battery module is the parallel connection.

21. The control method of claim 20, wherein determining the connection configuration between the first battery module and the second battery module further comprises:
acquiring a required rotational speed of the electric vehicle;
determining whether the required rotational speed is greater than a rotational speed threshold; and
in a case that the required torque is not greater than the torque threshold and that the required rotational speed is greater than the rotational speed threshold, determining that the connection configuration between the first battery module and the second battery module is the series connection.
